(19) United States
(12) Patent Application Publication
(10) Pub. No.: US 2011/0083773 A1
(43) Pub. Date: Apr. 14, 2011

(54) METHOD AND ARRANGEMENT FOR JOINTING WOOD VENEERS TO EACH OTHER

(75) Inventor: Pekka Runonen, Vantaa (FI)

(73) Assignee: Raute Oyj

(21) Appl. No.: 12/895,944

(22) Filed: Oct. 1, 2010

(30) Foreign Application Priority Data
Oct. 9, 2009 (FI) 20096043

(51) Int. Cl. B27D 1/10

(52) U.S. Cl. 144/344; 144/4.7

(57) ABSTRACT

The invention relates to a method and an arrangement for jointing wood veneers to each other with an edge joint. In the method, the veneers to be jointed are first positioned with edges to be jointed against each other, and thereafter a jointing operation of the veneers to each other is performed at connection points spaced from each other in the longitudinal direction of a joint between the veneers. The method comprises forming in the to-be-jointed veneers a row of not less than three through-holes at said connection points, said row extending across the joint between the abutting edges of the veneers to be jointed, such that one of the holes substantially coincides with the joint, and thereafter attaching the veneers to each other by means of splicing tools to be fitted in the holes.

### CROSS-REFERENCE TO RELATED APPLICATION

This application claims priority from and the benefit under 35 U.S.C. §119 of Finnish Patent Application No. 20096043, filed Oct. 9, 2009 in the Finnish Patent Office, which is hereby incorporated herein by reference in its entirety.

### FIELD OF THE DISCLOSURE

The present invention relates to a method for jointing wood veneers to each other with an edge joint, in which method the veneers to be jointed are first positioned with edges to be jointed against each other, and thereafter a jointing operation of the veneers to each other is performed at connection points spaced from each other in the longitudinal direction of a joint between the veneers. The invention is also related to an arrangement for jointing wood veneers to each other.

### BACKGROUND OF THE DISCLOSURE

Wood veneers are used e.g. for manufacturing plywood panels and LVL's. Veneers are usually produced by slicing the same off of a block of wood in a veneer lathe, resulting in relatively long strips with fibers extending substantially crosswise with respect to the longitudinal direction of the strip. Then, according to intended use, from these veneer strips are clipped veneer sheets which are used e.g. for the manufacture of plywood panels. A typical size of the plywood panel is 8×4 feet (or 4×8 feet), the first figure indicating the size of a plywood panel in grain direction. The length of a block of wood is typically about 8 inches more than the grain-direction size of a plywood panel to be manufactured, and the veneer sheets are cut to a size slightly larger than the width of a finished plywood panel, typically about 9 inches wider, in order to account for shrinkage in 8×4 foot plywood in the drying process. The thickness of veneers is typically within the range of about 1-4 mm.

Veneer strips exhibit a variety of inherent defects, such as large knotholes, splits, end wane or reject end flaw, etc., which is why it is often necessary to cut the same into sheets smaller than what is required for the size of a final plywood panel. It is typical in the production of plywood boards that about 5-10% of veneers are undersized, whereby such smaller size veneer pieces must be nearly always spliced to each other in the industrial production of plywood panels for ensuring a sufficient yield. Splicing or jointing is performed by placing the to-be-spliced edges of veneers against each other, such that the joint between veneers extends in a substantially crosswise direction with respect to the grain-direction extent of the veneers. Such veneer webs, made up by undersized veneers spliced together, are then cut into veneer sheets matching a full-size veneer and being typically used in the core plies of plywood panels. Veneers are sorted out at a high precision according to intended use after the drying process prior to conveying the same to a splicing process. Sorting can be performed as early as in a wet condition with just those veneers being singled out which are to be conveyed to the splicing process.

The prior art discloses joining methods for undersized veneers by employing various adhesive tapes and sewing techniques, which nevertheless are not applicable until after the drying process. The publication WO 00/32370 describes one method for bonding surface veneers to each other by means of an adhesive joint. Currently employed is also a method, in which the veneers are bonded after the drying process by means of adhesive filaments extending crosswise relative to joints between veneers, and which method comprises making spot type gluing points on a joint between the to-be-bonded veneers. The purpose of adhesive spots is to inhibit the overlapping of plywood panels during subsequent processing and the purpose of adhesive filaments is to increase the lengthwise strength of a joint. The publication U.S. Pat. No. 4,545,845 describes one assembling method for veneers by means of adhesive. The publication U.S. Pat. No. 3,732,833 describes assembling veneers by a stitching operation, which comprises making individual holes used for producing a continuous thread line extending across the entire width of the veneers. One problem with the prior known ways of assembling veneers is that, after the drying process, the veneers to be joined have increased brittleness, resulting in a difficult sewing process and making the veneers relatively susceptible to splitting, nor is the thus produced joint connection always capable of withstanding stresses applied to the joint in subsequent processing but, instead, the veneers may end up e.g. in a partially overlapped relationship, such veneers being no longer useful in further processes, but having to be returned as reject. These problems have been addressed by developing various wet joining methods, such as sewing veneers to each other by means of a stitch established across a joint between veneers, as disclosed e.g. in Patent publications U.S. Pat. No. 3,856,600 and U.S. Pat. No. 3,919,954. Sewing methods have been described also in Patent publications EP 0528717, GB 1166570. Wet joining refers to the bonding of veneers to each other prior to a drying process while the moisture content of veneers is within the range of about 40-150% of the dry weight thereof. The post-drying moisture content of veneers is typically about 2-12% of the dry weight thereof. Over the course of a drying process, the veneers typically exhibit shrinkage of 5-10% in a cross-fiber direction. One of the benefits of a wet joining method is e.g. energy saving as the unnecessary drying of rejected material is avoided. Another advantage is that there is no need to feed the dryer with easily jamming veneers, and that labor is reduced by the immediate removal of debris.

### BRIEF SUMMARY OF THE DISCLOSURE

A goal of the present invention is to provide an improved method and arrangement, whereby side-by-side veneers can be assembled with a strong joint capable of holding the side-by-side veneers in attachment with each other in various directions for the duration of an entire subsequent process that follows the joining The solution according to the invention is applicable to wet joining, making it possible to provide a joint that withstands stresses caused e.g. by a drying process, but it is also conceivable for use in the joining of veneers taking place after the drying process.

In order to achieve said goals of the invention, a method according to the invention is characterized in that the method comprises forming in the to-be-joined veneers a row of not less than three through-holes at said connection points, said row extending across the joint between the abutting edges of the veneers to be joined, such that one of the holes substantially coincides with the joint, and thereafter attaching the veneers to each other by means of connecting means to be fitted in the holes.

An arrangement of the invention, on the other hand, is characterized in that the arrangement comprises means for making a row of not less than three through-holes in the to-be-joined veneers at said connection points, said row of holes extending across the joint between the abutting edges of the veneers to be joined, such that one of the holes substantially coincides with the joint, and connecting means to be fitted in the holes for attaching the veneers to each other.

A benefit provided by the solution of the invention is that the joint consists of individual robust connection points, the location of which is relatively easy to move around within a certain tolerance range, on the basis of information provided e.g. by camera imaging, thus avoiding the making of a series of holes required by the joint e.g. in a knot region, which does not retain the joint because the knot region falls off, or avoiding the coincidence of a series of holes with a knothole or some other void that would disable making the joint in an appropriate manner. A hole to be made in the joint allows for making a locking connection therein, whereby the side-by-side veneers interlock effectively in both longitudinal and lateral directions of the veneers, as well as in a perpendicular direction thereof. Individual connections can be constructed by using a single work head, which makes the holes needed at each connection point and thereafter conducts assembling of the veneers by means of a thread or a separate connecting member, and thereafter proceeds forward in the joint direction to the next connection point. The connections can also be made simultaneously by means of a work station, which extends essentially over the entire length of the joint and which carries a plurality of work heads for making simultaneously a series of holes needed for each connection point and likewise for performing simultaneously the subsequent jointing operation at each connection point. Even in this latter case, the individual work heads are preferably movable in the joint direction within a specific tolerance range, on the basis of information provided e.g. by camera imaging, for ensuring the appropriate and correct positioning of each connection point. The work head may also have limiter elements, which automatically disable the operation of a punching tool because of an excessively hard knot region, and preferably said elements are also provided with a feedback to the control about punching not being successful, and the jointing process of this particular connection point is skipped over.

The number of holes formed at each connection point is preferably not less than three, the hole spacing being within the range of 5-20 mm, preferably about 15 mm. The holes have a diameter e.g. within the range of about 5-10 mm in the case of circular holes. The holes may also have a shape other than circular. The distance between connection points is preferably within the range of about 150-400 mm, but it may differ even considerably from this figure, depending, among other things, on the type of wood, the dimensions and moisture content of veneers.

### BRIEF DESCRIPTION OF THE SEVERAL VIEWS OF THE DRAWINGS

The invention will now be described more precisely with reference to the accompanying drawings, in which:

FIG. 1 shows a schematic presentation of two veneer sheets being assembled to each other;

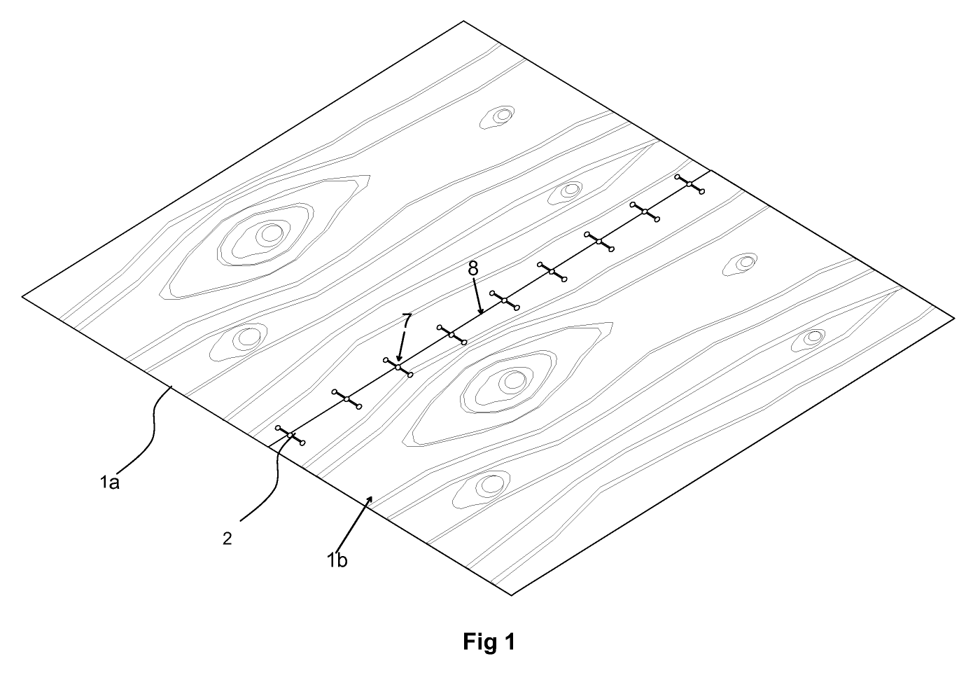

FIG. 2 shows connection points in a slightly enlarged view;

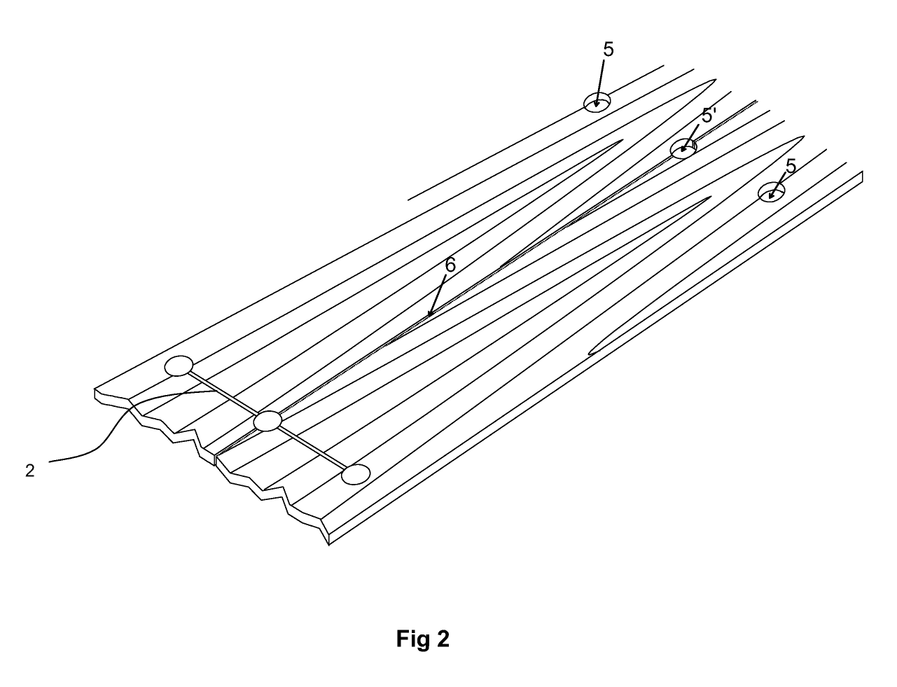

FIG. 3 shows one splicing member of the invention in a slightly enlarged view, the veneer sheets to be fixed in place being shown cut off at a connection point; and

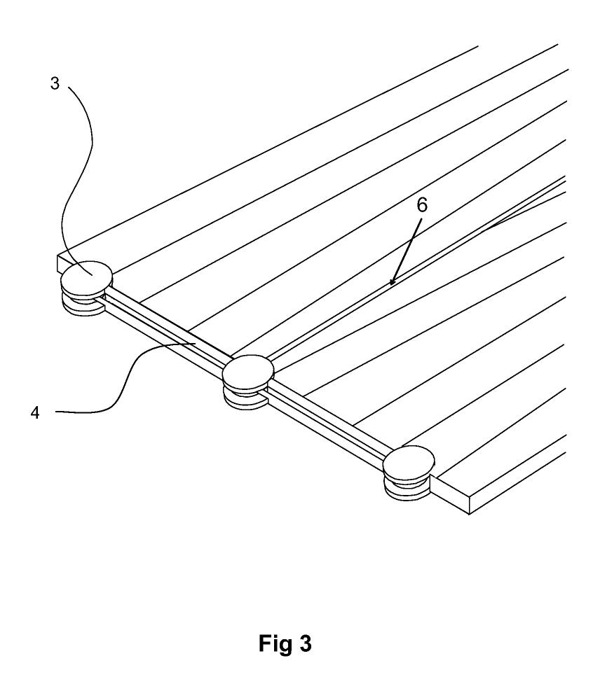

FIG. 4 shows the splicing member of FIG. 3 in more detail.

### DETAILED DESCRIPTION OF THE DISCLOSURE

A few ways of carrying out the jointing process will now be described by way of example.

The trailing edge of an assembled veneer web and the leading edge of a veneer to be joined to the veneer web are initially parked underneath a jointing unit while in tight contact with each other. The distance between connection points 7 is determined as necessary, for example at 100 mm. A punching tool is used for punching along the connection point e.g. three side-by-side holes 5, of which a middle one 5′ is divided half and half for each veneer. An optimal shape for the holes can be found out experimentally, and it can be for example a circular hole about 5-6 mm in diameter. The punching tool can be for example a die cutter type of tool or a drilling tool. The number of holes is preferably three, but is not limited to that, nor is the location thereof necessarily symmetrical with respect to the joint. A function of the holes, among other things, is to prevent the veneer from cracking in subsequent operations and to ensure that the splicing is not attempted at such a location in which the hole punching cannot be performed, for example because of an excessively hard knot region. The punching tool is preferably provided with an overload limiter and a sensor system and a feedback to the control in such a way that, in case the punching is not successful, the making of a splice at this particular spot is not continued. The middle hole 5′ is intended for immobilizing the binding at a joint 6 in every direction.

Once the holes have been constructed, the attachment of veneers 1a, 1b to each other is performed by means of connecting means, which can be e.g. in the form of a tie filament, or a specially designed connecting member 2 adapted to the hole spacing and consisting of two elements, each of which comprising connecting elements 3 and linking elements 4 therebetween. The connecting elements 3 are pushed from the opposite sides of veneers into the holes 5, 5′ and locked to each other. Some or all of the connections can be produced with one and the same jointing head by moving either the veneer or the jointing head to a new connection position. The best capacity is naturally achieved if each connection position is provided with its specific jointing head and the connections are made simultaneously.

When using a tie filament connection, the holes 5, 5′ facilitate the threading of a tie filament into the binding as threading tools fit through the hole made in the veneer. At the same time as the holes are punched there are recesses for filaments formed in the connection point, preferably by pressing. If necessary, the pressing of a recess can also be implemented by using a heatable recessing tool. The purpose of recesses is to facilitate the making of a tighter binding with lesser force and to strengthen the binding in every direction as the filament positions itself in the recess, whereby it cannot very easily become dislodged. In addition, the recesses prevent the tie filament from becoming visible in a finished product. If necessary, the recessing tool can also be used for making an extra cut in the outermost holes in a filament tightening direction, whereby the filament in a tightened condition finds its way into the cut. This further enhances immobilization of the tie filament.

Making a binding can be conducted with per se known filaments, either with or without adhesive. The filament is preferably of such a type that shrinks at a drying temperature, preferably more than the shrinkage of wood, for example 10 . . . 20%, making the binding tighter and hence more effective.

The filament binding can be made e.g. as follows:
1. Filament is unwound upon a row of holes in a length sufficient for making a binding.
2. Filament is pushed with a tool through the middle hole for a loop on the other side of a veneer, and it is held with said tool such that the filament loop has a direction which is perpendicular to the other holes.
3. Filament cutting is performed.
4. Filament ends are pushed, each with its specific tool, through the outermost holes.
5. Grippers are pushed through the filament loop present in the middle hole.
6. The pusher that had been driven through the middle hole is withdrawn to a basic position.
7. Each gripper is used to take hold of the end of a filament brought through the hole of the opposite side.
8. While holding on to the ends of filaments, the grippers are pulled through the filament loop present in the middle hole, hence tightening the filament binding at the same time.
9. The grippers are pulled towards each other, such that the filament ends are left with loops between the grippers and the location of a noose.
10. A third gripper is used to execute a handover of the grip from the second gripper for bringing the ends of the filaments to cross each other.
11. The grippers are pulled again outward from the binding, whereby the binding forms a noose at the middle hole.
12. If necessary, the binding is completed by clipping an extra length off of the ends of the filaments.

If necessary, items 9-11 can be replaced by ensuring the binding reliability, for example by gluing with a PUR adhesive capable of withstanding the drying temperature.

The connection can also be made with a separate connecting member, consisting for example of a composite in which the employed fiber comprises for example a type of filament similar to what is used in the foregoing filament binding solution, said member having connecting elements 3 cast thereon, such that relevant connecting elements are punched in finished holes on both sides of the veneer and that the connecting elements engage reliably with each other upon punching. The connecting elements may constitute an elongate connecting element tape, of which is removed a length needed for each binding location, e.g. the length of three connecting elements. The connecting member can also be an implement manufactured in one separate integral piece, e.g. by casting, in which a linking element 4 between the hole-fitting connecting elements 3 has been produced as a sort of filament or tape. The connecting elements 3 must have such a modest height that such connecting elements do not exceed the thickness of a veneer in the process of pressing the veneers for a product, whereby, in the case of e.g. a 3.2 mm veneer, the connecting element 3 has a thickness of about 3 mm or slightly less. The connecting elements must preferably be slightly larger in diameter than the holes 5 made in a veneer for the connecting elements to remain immobilized as well as possible. The connecting member's raw material is preferably plastics or a plastic composite with a melting temperature of more than 200° C.

When using a connecting member, the splicing of veneers to each other takes place for example as follows:
1. A new connecting member is placed in punching tools on both sides of a veneer.
2. The connecting elements are punched together from both sides of the veneer, said elements thus forming a solid binding with each other and with the joint.
3. At the same time, if necessary, the connecting member is released from the connecting element tape.

One of the benefits gained by this option is the speed of making a binding and the simplicity of an actual jointing tool.

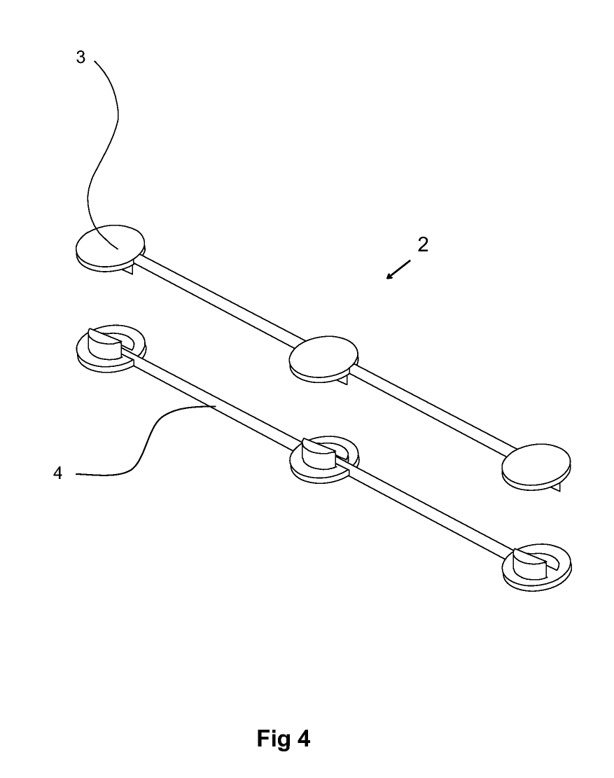

Also conceivable is the use of an implementation, in which veneers are attached to each other by means of loose filaments extending between the holes on both sides of veneers, said filaments being locked in each hole by separate connecting elements, such as the one 3 shown in FIG. 4. This implementation allows for larger tolerances regarding a distance between the holes.

That which is claimed:

1. A method for jointing wood veneers to each other with an edge joint, in which method the veneers to be jointed are first positioned with edges to be jointed against each other, and thereafter a jointing operation of the veneers to each other is performed at connection points spaced from each other in the longitudinal direction of a joint between the veneers, wherein the method comprises forming in the to-be-jointed veneers a row of not less than three through-holes at said connection points, said row extending across the joint between the abutting edges of the veneers to be jointed, such that one of the holes substantially coincides with the joint, and thereafter attaching the veneers to each other by means of connecting means to be fitted in the holes.

2. A method as set forth in claim 1, wherein the employed connecting means comprises a filament, which extends through the holes and which, after tightening the filament, is formed with a locking noose in alignment with the hole present at the joint

3. A method as set forth in claim 1, wherein the employed connecting means comprises a filament, which extends through the holes and which, after tightening the filament, is provided with an adhesive locking in alignment with the hole present at the joint.

4. A method as set forth in claim 1, wherein the employed connecting means comprises a filament, which is tightened in place by means of a clamping element to be fitted in at least one of the holes.

5. A method as set forth in claim 1, wherein the employed connecting means comprises a special connecting member, which consists of integral connecting elements, which position themselves on both sides of to-be-jointed veneers and are adapted to the hole spacing, and which have connecting elements therein adapted to engage with each other inside the holes by means of snap fitting.

6. A method as set forth in claim 1, wherein between the holes is formed a recess for accommodating a portion of the connecting means extending between the holes.

7. An arrangement for jointing wood veneers to each other with an edge joint, said arrangement comprising means for positioning veneers to be jointed with edges to be jointed against each other, and means for making a splice between the veneers at connection points spaced from each other in the longitudinal direction of a joint between the veneers, wherein the arrangement comprises means for making a row of not less than three through-holes in the to-be-jointed veneers at said connection points, said row of holes extending across the joint between the abutting edges of the veneers to be jointed, such that one of the holes substantially coincides with the joint, and connecting means to be fitted in the holes for attaching the veneers to each other.

8. An arrangement as set forth in claim 7, wherein the connecting means comprises a filament.

9. An arrangement as set forth in claim 7, wherein the connecting means comprises a special connecting member, which consists of integral connecting elements, which position themselves on both sides of the to-be-jointed veneers and are adapted to the hole spacing, and which have connecting elements therein adapted to engage with each other inside the holes by means of snap fitting.
